(19) United States
(12) Patent Application Publication
(10) Pub. No.: US 2019/0366329 A1
(43) Pub. Date: Dec. 5, 2019

(54) SYSTEM, DEVICE AND METHOD FOR DETECTING AT LEAST ONE VARIABLE DURING A BIOLOGICAL OR CHEMICAL PROCESS

(71) Applicant: PreSens Precision Sensing GmbH, Regensburg (DE)

(72) Inventor: Gernot Thomas John, Koefering (DE)

(21) Appl. No.: 16/425,471

(22) Filed: May 29, 2019

(30) Foreign Application Priority Data
May 30, 2018 (DE) 102018112895.9

(51) Int. Cl. B01L 3/00; G01N 21/01; G01N 21/35

(52) U.S. Cl. CPC B01L 3/5023; G01N 21/01; B01L 2300/0851; B01L 2300/0636; G01N 21/35

(57) ABSTRACT

A system for detecting at least one variable of a liquid sample (2) being moved in a container (1) during a biological or chemical process is disclosed. The container (1) comprises a bottom (5), a plurality of walls (3₁, 3₂), and an opening (4) opposite the bottom (5). A wall (3₂) forms an obtuse angle (β) with the adjacent walls (3₁) respectively. A reflection element (7) is formed on the wall (3₂). A measuring unit (10) has a radiation source (11). A sensor (12) is assigned to the bottom (5) of the container (1) in such a way that a beam (11E) emerging from the radiation source (11) is directed to the reflection element (7) and from there through the wall (3₂) to the sample in the container (1). The bottom (5) is transparent to a wavelength range of a radiation (11A) emerging from the sample (2). The sensor (12) of the measuring unit receives radiation (11A) from the sample (2). A device and a method for detecting at least one variable of liquid samples (2) during a biological or chemical process are also provided by the invention.

### CROSS-REFERENCE TO RELATED APPLICATIONS

The present non-provisional application is filed under 35 U.S.C. §§ 111(a) and 119 and claims the benefit of German Patent Application No. DE 10 2018 112 895.9, filed on May 30, 2018, which application is incorporated herein by reference in its entirety.

### FIELD OF THE INVENTION

The invention relates to a system for detecting at least one variable of a liquid sample moved in a container during a biological or chemical process.

Furthermore, the invention relates to a device for detecting at least one variable of a plurality of liquid samples in a plurality of containers during a biological or chemical process.

The invention also relates to a method for detecting at least one variable of a plurality of liquid samples in a plurality of containers during a biological or chemical process.

### BACKGROUND OF THE INVENTION

European Patent EP 1 730 494 B1 discloses a method and a device for recording process parameters of reaction liquids in a plurality of microreactors, which are continuously agitated (shaken), at least until the termination of the reaction in all the microreactors. The process parameters in the microreactors are recorded during the reaction by means of at least one optical sensor system. The optical sensor system is not moved during the detection of the values of a process parameter like, for example, the detection of a current value of the self-fluorescence of the reaction liquid. The occurring relative movement between the agitated microreactors and each optical sensor system is not problematic when the electromagnetic radiation from each optical sensor system is introduced exclusively into one of the microreactors concerned, during the recording of the process parameter in said microreactor, and the radiation emitted from the reaction liquid is only incident on the sensor of the corresponding optical sensor system. The measurement is carried out in continuously agitated reactors, wherein each optical sensor system aligned under the microreactors of the microtiter plate is not moved, at least during the recording of the process parameters, so that the agitated microreactors are able to move relative to each optical sensor system.

European Patent EP 1 494 007 B1 discloses a device and a method for determining parameters of fluid-containing samples. The samples are irradiated individually with light emerging from a light source in a substantially vertical irradiation direction. A detector is provided for measuring the light emerging from a single sample. This detector has a detection direction which lies on an optical axis which is substantially parallel to the optical axis of the light source. By means of a mirror surface, the light, arriving substantially vertically from the light source, is at least partially deflected in a substantially horizontal transmission direction.

German Patent Application DE 10 2008 008 256 A1 discloses a microreactor having at least one cavity which has a bottom, a side wall, and an opening opposite the bottom. The cross-section of the cavity has a shape deviating from a round, square, or rectangular shape.

U.S. Pat. No. 8,405,033 B2 discloses a sensor for the rapid detection of the particle concentration in a liquid. The particle concentration is measured through the wall of a container. Various types of containers can be used. The sensor comprises one or more light sources and one or more sensors housed in a sensor housing. According to an embodiment, the container is a well plate. Outside each well, the bottom of each well is assigned to a light source and a sensor.

U.S. Pat. No. 8,603,772 B2 discloses a method and a device for detecting particle size and/or particle concentration. For this purpose, one or more light sources and one or more detectors are contained in a housing which is interfaced to a medium to be tested. The device is also suitable for the non-invasive measurement of biomass in a bioreactor.

U.S. Pat. No. 6,673,532 B2 discloses a bioreactor using a non-invasive optical chemical detection method. A light source excites an optical-chemical sensor whose optical response is measured by a detector. According to an embodiment, each reactor is assigned to an LED and a detector. The light is carried out through a side wall of the container. The detection is carried out through another side wall of the container.

U.S. Pat. No. 7,339,671 B2 discloses a method and a device for real-time and online monitoring of cell growth and concentration in a dynamic cell culture environment. Techniques are used which suppress the noise from ambient light, non-uniform scattering distribution, and effects of reflection in a dynamic environment.

German Patent DE 10 2014 001 284 B3 discloses a device and a method for determining the optical density and/or the change in the optical density of a reaction mixture in a shaken reactor. In this case, light emerging from at least one light source enters the reaction mixture. The light leaving the reaction mixture is detected by at least one light sensor. During the detection of the light by means of the at least one light sensor, the reactor and the reaction mixture are shaken. The detection of the light by at least one light sensor is carried out with a frequency, such that the shaking frequency is not an integer multiple of the detection frequency, and at least two measuring points detected by at least one light sensor in a specific time interval are combined into a measurement series. The reaction mixture is shaken continuously. There is no relative movement between the reactor, the light sources, and the light sensors during the recording of a measurement series.

International Patent Application WO 2016/066156 A2 relates to a mobile photometric measuring device with at least one measuring module, which consists of a light source, a detector, and an optical structure with optics with integrated filter properties. In an embodiment, likewise, an optic and at least one filter are provided. These components are arranged on a circuit board, in a housing and/or interconnected with a component. Furthermore, the invention relates to a mobile photometric measuring method on microtiter plates with grid sensors.

German Patent Application DE 10 2008 008 256 A1 discloses a microreactor having at least one cavity which has a bottom, a side wall, and an opening opposite the bottom. The microreactor has a cross-section parallel to the bottom of the side wall, which cross-section has a shape deviating from a round, square, or rectangular shape.

European Patent Application EP 0 517 339 A1 describes a method for determining the concentration of a substance with the aid of an ion-selective electrode. Likewise, a device for performing said method is disclosed.

U.S. Patent Application No. 2018/0071731 A1 discloses a multiwell assembly with a microplate and a cover. The microplate comprises a set of wells. Each well defines an opening. The cover comprises a body and a shutter. The body of the cover is disposed over the microplate. The shutter is mounted to the body such that the shutter is movable over a range of travel between a first position, in which the shutter occludes the openings of the set of wells, and a second position, in which the shutter is in offset relationship to the openings of the set of wells.

German Patent Application DE 10 2011 000 891 A1 discloses a method and a device for determining at least one variable of a sample located in a moving container. The container is moved in a defined manner and the at least one variable is determined. In this case, the determination of the at least one variable is timed with a movement state of the sample resulting from the movement of the container. For carrying out the method, a carrying element for the container is provided, wherein a defined movement can be carried out with the carrying element. Likewise, a measuring system is provided by which at least one variable of the sample can be determined. At least one synchronizing element is provided by means of which the determination of the at least one variable can be timed with a movement state of the sample that can be generated by the movement of the container.

Microtiter plates, which are a matrix of a plurality of containers rigidly connected to one another, are well known in the art (See www.sigma-aldrich.com).

In a variety of studies in various fields, such as chemistry, pharmacy, or the life sciences, samples are analyzed in containers which are moved or agitated to support the intended processes in a particular test. This is preferably carried out in a mechanical manner; for the person skilled in the art, corresponding devices, such as shakers or rockers, are known. Such devices are commercially available in embodiments which can move a container, but also a plurality of containers simultaneously in a defined manner. The purpose of the movement is usually to achieve a thorough mixing of the sample, which is present as a liquid or fluid medium, such as a solution, emulsion or suspension. The sample may also be a fluid medium in which microorganisms develop.

### SUMMARY OF THE INVENTION

It is therefore an object of the invention to provide a system for detecting at least one variable of a liquid sample during a biological or chemical process, allowing a cost-effective, non-invasive, and efficient measurement under reproducible conditions for a long duration of time.

This object is achieved by a system for detecting at least one variable of liquid samples during a biological or chemical process. The liquid sample is in a container defined by a bottom, a plurality of walls, and an opening opposite the bottom, wherein the container receives the liquid sample to perform the biological or chemical process in the container. A single wall of the container forms an obtuse angle with the adjacent walls of the container. A reflection element is formed on the single wall. A measuring unit having a radiation source and a sensor is assigned to the bottom of the container in such a way that a beam emerging from the radiation source is directed to the reflection element and continues through the wall to the liquid sample in the container. The bottom is transparent for a wavelength range of a radiation emerging from the liquid sample, and the sensor of the measuring unit receives radiation from the sample.

It is also an object of the invention to provide a device for detecting at least one variable of a plurality of liquid samples in a plurality of containers during a biological or chemical process, which allows an uninterrupted, non-invasive, and simultaneous measurement under reproducible conditions over a long period of time on a plurality of containers. The measurement should have a high throughput and a dynamic measuring range.

This object is achieved by a device for detecting at least one variable of at least one liquid sample in a plurality of containers during a biological or chemical process. The device has a measurement carrier. A moving component moves the measurement carrier in a combined movement defined by movements in an X-coordinate direction and a Y-coordinate direction. A matrix of a plurality of containers, rigidly connected to one another, is positioned on the moving component. Each of the containers is defined by a bottom, a plurality of walls and an opening opposite the bottom. The matrix is constructed by a plurality of base modules. Each base module of the matrix is constructed of four containers connected to one another. The base modules of the matrix are also rigidly connected to each other. A central channel of the base module defines a respective wall of each of the four containers of the module. An end of the channel of the base module defines four reflection elements. One of the four respective reflection elements is assigned to the wall of each container of the base module. A plurality of measuring units is arranged in the measurement carrier. Each measuring unit has at least one controllable radiation source of electromagnetic radiation and at least one sensor for detecting electromagnetic radiation. The plurality of measuring units is arranged and distributed in the measurement carrier in such a way that, if a matrix is seated on the measurement carrier, each respective radiation source is assigned to a reflection element of each container and at least one respective sensor is assigned to the bottom of each of the containers.

It is another object of the invention to provide a method for parallel detection of at least one variable of a plurality of liquid samples in a plurality of containers during a biological or chemical process, the method allowing uninterrupted, non-invasive, and simultaneous measurement under reproducible conditions over a long time on a plurality of containers with a liquid sample. Furthermore, the method according to the invention should allow for more cost-effective operation.

This object is achieved by a method for detecting at least one variable of a plurality of liquid samples in a plurality of containers during a biological or chemical process. The method comprises the steps of:

filling at least one container of a matrix of a plurality of containers with the liquid sample, the matrix being made up of a plurality of base modules, each base module being composed of four containers connected to one another, wherein a central channel defines a respective wall of each of the containers, and an end of the channel of the base module defines four reflective elements, wherein a respective reflection element is assigned to the respective wall of each container of the base module;

placing the matrix on a measurement carrier such that each of the plurality of measuring units arranged in the measurement carrier is assigned to one of the containers of the matrix, so that at least one controllable radiation source of the measuring unit is assigned to the reflection element of each container, and at least one sensor of the measuring unit is assigned to a bottom of each container;

moving the measurement carrier in the X-coordinate direction and in the Y-coordinate direction, wherein the movement of the measurement carrier is performed radially and orthogonal to the gravitational force about a fixed axis, and wherein in each base module of the matrix, dependent on the movement, the liquid sample alternately accumulates on the wall of each container of the base module;

triggering at least one controllable radiation source of each measuring unit in such a way that electromagnetic radiation is irradiated into the sample just accumulated on the wall of the respective container by way of the reflection element and the wall of each container; and,

collecting, by means of the respective sensor of the respective measuring unit, the electromagnetic radiation emerging through the respective bottom of each container of the matrix, wherein a determination of the at least one variable during the biological or chemical process is performed in the at least one container of the matrix.

The system according to the invention and the device according to the invention serve for the parallel detection of at least one variable of a sample in one container or a plurality of samples in a plurality of containers during a biological or chemical process. The variables generally include the turbidity and the optical density of liquid samples, and in particular the cell density, biomass concentration, cell concentration, pH value, O₂ saturation of the liquid, and the ambient temperature.

The system according to the invention serves to detect at least one variable of liquid samples in a container during a biological or chemical process. The container comprises a bottom and a plurality of walls. Opposite the bottom an opening is provided, which serves to receive a liquid sample into said container. The container according to the invention has a wall which forms an obtuse angle with the adjacent walls of the container. A reflection element is formed on the wall, the reflection element being assigned to a radiation source of a measuring unit. The measuring unit, having the radiation source and a sensor, is assigned to the bottom of the container. By means of the reflection element, a beam is directed from the radiation source through the wall onto the sample in the container. The bottom of the container is transparent to a wavelength range of radiation from the sample. To detect the scattered radiation emerging from the sample through the bottom, a sensor is assigned to the bottom. The configuration of the wall with the reflection element has the advantage that the light from the radiation source is incident on the wall substantially perpendicularly, so that it reaches the sample substantially without significant reflection. The wall with the reflection element is transparent to the wavelength range of the radiation, at least in the region in which the beam emanating from the reflection element is incident on the wall.

In one embodiment, the container is made of a plastic by means of an injection molding process. In this case, the tool for producing the container is configured such that the reflection element and the container are produced in one step. The advantage here is that the reflection element is thus an integral part of the container and is firmly bonded to the wall of the container.

It is not necessary that the entire wall with the reflection element is transparent. It is sufficient if at least a portion of the wall, which is assigned to the reflection element, is transparent to a wavelength range of the beam from the radiation source. Likewise, at least a portion of the bottom assigned to the sensor should be configured transparent to a wavelength range of the radiation (scattered radiation) from the sample.

For the measurement, the container is mounted on a measurement carrier, which comprises the measuring unit having the radiation source and the sensor.

The device according to the invention serves to detect at least one variable of liquid samples during a biological or chemical process. The device comprises a measurement carrier with a moving component that moves the measurement carrier in a composite movement composed of an X-coordinate direction component and a Y-coordinate direction component. A plurality of measuring units are arranged in the measurement carrier, each measuring unit comprising at least one controllable radiation source of electromagnetic radiation and at least one sensor for detecting electromagnetic radiation (scattered radiation from the liquid sample). For the measurement on the liquid samples, a matrix of a plurality of containers rigidly connected to one another (interconnected) is provided. The containers define a substantially square cross-sectional shape. Each of the containers has a bottom and a plurality of walls. An opening is provided opposite the bottom, wherein the containers can be filled through said opening. The matrix consists of a plurality of base modules. Each base module is constructed of four interconnected containers to which a central channel is assigned such that in each case one wall of the channel belongs to one of the four containers. One end of the channel of each base module defines four reflecting elements, one reflecting element each being assigned to the wall of each container of the base module. The plurality of measuring units are arranged in a distribution throughout the measurement carrier in such that, when a matrix seated on the measurement carrier, one radiation source is assigned to each reflection element of each container. Furthermore, at least one sensor of the measuring unit is assigned to the bottom of each of the containers.

The device according to the invention has the advantage that the plurality of containers of the matrix are arranged in columns and rows. The containers of the matrix are all rigidly connected to one another. Microtiter plates are configured such that the matrix for the measurement can be detachably but stationarily connected to the measurement carrier. This also achieves an unambiguous assignment of the radiation source and the sensor to the respective containers of the matrix.

Furthermore, the device according to the invention has the advantage that it is possible to track and record changes in turbidity as well as changing cell and biomass concentrations in the containers as a result of cell proliferation processes of living cultures over the entire period of the culture time. At the same time, different samples in different incubation environments, as well as their reaction to reagents, can be analyzed in parallel. In addition, for a measurement of cell and biomass concentrations, the containers need not be transported to a measuring apparatus, oftentimes in a different location. The measurement can be automated according to the invention and carried out at arbitrary times without operating personnel required. This saves costs.

The scattered light that passes from the sample to the sensor may be generated by physical processes, such as reflection at interfaces and diffraction, depending on the refractive index of the material present in the sample. The scattered electromagnetic radiation thus also is produced due to the scattering at the biological material present in the respective container. According to an embodiment, the electromagnetic radiation is light having a wavelength between 600 and 900 nm.

With the device according to the invention, changing process variables of cell suspensions in continuously and non-continuously shaken containers can be detected automatically and simultaneously. In an embodiment, to generate a movement of the measurement carrier for the containers, a combined movement composed of the X-coordinate direction and the Y-coordinate direction is provided, which generates a corresponding shaking or rotary movement of the matrix. In an embodiment, the measurement carrier is thereby movable with a defined, radial movement, orthogonal to the gravitational force about a fixed axis.

The radiation source which is installed in the measuring unit contains at least one light-emitting diode, wherein an optical system for guiding and forming the electromagnetic radiation is arranged downstream of said light-emitting diode. The forming of the electromagnetic radiation is essentially a collimation. The electromagnetic radiation comprises a wavelength range of 600 nm to 900 nm.

The light of the light-emitting diode or laser diode is irradiated by the optical system into the respective assigned container, wherein substantially the lens collimates the electromagnetic radiation in the liquid sample into a cylinder.

Preferably, each measurement carrier is provided with an electronic module with which there is also a data connection (for example, a radio connection) to a base station. The electronic module also serves to supply power to the light-emitting diode and possibly the sensors, to control the light-emitting diode of each measuring unit of each container and to record the measured values from the sensor of the measuring unit.

Through a cylindrical light-emitting diode with a maximum of 3 mm diameter and at least 7000 mCd radiant power in combination with the downstream optical system (collimator), electromagnetic radiation of a dominant wavelength in the range between UV-IR, or 600 to 900 nm, is irradiated through the bottom which is arranged to be transparent to the radiation or at least transparent to the measuring range into the respective container (microbioreactor of the matrix). The beam is collimated such that a light cylinder is formed in the liquid sample, and the light cylinder has a maximum of 1.5 mm diameter at a length of at least 10 mm from the exit location. The scattered light generated on the sample can be supplied to the sensor of the measuring unit via an optical filter. As sensors or light sensors, for example, a low-noise Si photodiode with an integrated amplifier having a measuring frequency of at least 10 kHz, suitable for coupling with optical fibers, can be used.

In an embodiment, the configuration of the matrix of the containers is such that each of the containers is a microbioreactor with a transparent bottom, which is located above the sensor of the measuring unit of the measurement carrier for detecting turbidity, biomass concentration and cell concentration. A plurality of the microbioreactors are arranged in the matrix. The matrix is produced by an injection molding process, so that all containers of the matrix are rigidly connected to each other. The matrix is moved continuously around a fixed axis with a radius of 0.5-50 mm and a frequency of 0-2000 rpm. As a result, the sample is centrifuged in the direction of the walls (side walls) of the container (small bioreactor, microbioreactor), and a liquid column is formed in the corners and on the wall containing the reflection element. The formation of the liquid column on the wall with the reflection element is especially important so that the sample is present with sufficient volume in the measuring range in order to generate sufficient measuring signals.

The method according to the invention serves to determine at least one variable of a plurality of samples in a plurality of containers of a biological or chemical process of a liquid sample located in at least one moving or non-moving container of a matrix. The essential aspects of the method according to the invention are the moving of the plurality of containers arranged in the form of a matrix and rigidly connected to one another in a defined manner, and the determining of at least one variable of the liquid sample, the determination being timed by the liquid column formed on the wall with the reflection element. The movement of the container or containers generates the liquid column on the wall with the reflection element, so that the light from the radiation source and the assigned sensor can be triggered accordingly. Before the actual measurement, the filling of at least one of the plurality of containers arranged in the form of a matrix is carried out, wherein the matrix is arranged in stationary and defined manner on a measurement carrier.

The matrix is made up of a plurality of basic modules. Each base module comprises four interconnected containers, a central channel defining one respective wall of each of the containers. One end of the channel of the base module defines four reflecting elements, one reflecting element each being assigned to the wall of each container of the base module.

When moving the measurement carrier, at least one variable can be determined during the biological or chemical process. The movement of the measurement carrier is carried out continuously and with a defined, radial movement, orthogonal to the gravitational force (composed of an X-coordinate direction and a Y-coordinate direction) about a fixed axis. In each container in which a sample is located, the variable of the sample is determined with the measuring unit of the measurement carrier which measuring unit is permanently assigned to the container. The measuring units are arranged in the measurement carrier in such a way that, when the matrix placed on the measurement carrier, one measuring unit per one container is assigned. The measuring unit comprises a controllable radiation source and at least one sensor with which at least one variable of the sample is detected localized in the respective container.

A triggering of the at least one controllable radiation source of each measuring unit preferably is carried out in such a way that electromagnetic radiation is radiated into the sample (liquid column) which has just accumulated (collected) on the wall of the respective container by way of the reflection element and the wall of each container. The collection of the scattered light emerging from the sample is carried out by the respective sensor of the measuring unit. The light (the leaving electromagnetic radiation) passes to the sensor through the bottom of each container of the matrix.

For detecting at least one variable of the sample, an electromagnetic radiation is radiated by the radiation source through the wall of the respective container into the sample (liquid column on the wall with the reflection element). The scattered electromagnetic radiation of the at least one variable of the sample is then received through the bottom by means of at least one sensor of the measuring unit. By means of the sensor, a continuous, optical measurement and recording of scattered light, which is produced on the biological material as a result of the irradiation with electromagnetic radiation, can be carried out. At least one variable can be determined on the basis of the electromagnetic radiation scattered on suspended particles or on biological material. This optical response is detected by the sensor, which is assigned to the respective stationary container.

Likewise, the source of electromagnetic radiation or photodiode may be provided with a slight angle. This allows measurement closer to the wall and use of a large photodiode.

One contemplated variable may be the pH value. Another variable may be the relative saturation of dissolved oxygen in the sample, which may also be detected as an optical response from the sensor assigned to the respective container. The relative saturation of dissolved oxygen in the respective liquid sample can be regulated by a change in the energy input during the movement of the containers or of the carrier.

In embodiments, chemosensors are used to measure the pH value and the dissolved oxygen concentration in the containers (microbioreactors). The chemosensors contain photoluminescent dyes which emit electromagnetic radiation of specific wavelength in a defined manner when irradiated with electromagnetic radiation of a specific wavelength. The chemosensors react in direct contact with the sample present in the microbioreactors with a change in the intensity and decay time of the luminescence, which can be converted, after being measured by a light sensor, by means of mathematical methods into other values, such as, for example, the pH value and the concentration of dissolved oxygen.

Preferably, the radiation source comprises at least one light-emitting diode, which is assigned to an optical system for guiding the electromagnetic radiation. In an embodiment, the electromagnetic radiation is light with a wavelength of 600 to 900 nm. The at least one variable can be detected independently of the geometric dimension of a radial deflection of the movement. The measuring method records the measured values with a high measuring frequency by means of the sensor, which can generate 50 to 100,000 individual measured values during the periodically fluctuating height of the liquid column above the stationary sensor. Low measurement frequencies allow the use of simplified electronics and save battery capacity.

For a high-resolution detection of the periodically changing height of the scattered light signal, a high measuring frequency of the light sensor is necessary. This can be in the higher kHz or MHz range in order to extract measurement data for correlation with reference variables (OD₆₀₀, dry biomass, cell concentration) on the basis of periodically recurring, constant ranges within the measurement signal.

The scattered light signal measured by the sensor of the measuring unit is calculated from a defined interval of the raw data by means of suitable mathematical methods for conversion into reference values such as optical density, biomass or cell concentration at a fixed point in time (usually after the beginning of the process or the reaction). The calculation is performed in a base station (such as, for example, a computer) to which each measurement carrier is connected by way of a data connection. The communication between carrier and base station is preferably wireless.

A mathematical evaluation method runs on the base station, whereby the course of the time-resolved scattered light signal obtained is converted into a single measured value recorded at a fixed time after the start of the process with at least 50 measurement events per second. The mathematical evaluation method is configured in such a way that measurement data of periodically recurring ranges are selected and further processed within defined ranges that meet predefined criteria.

According to a developed embodiment of the invention, the moving component can be accommodated in an incubator together with the at least one measurement carrier.

In an embodiment, a base station communicates via the electronic module with the at least one measurement carrier in the incubator. The communication of the base station with the at least one measurement carrier in the incubator can be provided by way of a data connection (for example, a radio connection (Bluetooth, WLAN)). The strong miniaturization of the microtiter plate measurement carriers, each comprising twenty-four containers (microbioreactors), allows at least one measurement carrier per incubation environment. In an embodiment, a plurality of measurement carriers (for example, up to ten measurement carriers) can be accommodated on the moving component in the incubator. This results in an advantageous process for an uninterrupted, non-invasive, and simultaneous measurement on a plurality of containers, even on a plurality of carriers.

In an advantageous embodiment, the individual containers have a square cross-section and a volume of 500 to 11000 μl, which serves to receive the liquid sample. A plurality of measurement carriers may be positioned in a plurality of different incubators so that the measurement carriers are subject to different incubation environments and different movements of the moving component. This has the advantage that different incubation and/or shaker environments for the same sample can be realized, so that a variation of the technical test parameters, such as, for example, temperature, O₂/CO₂ saturation of the ambient air, and shaking frequency, can be realized in a simple manner.

In a preferred embodiment, the measurement carriers in the plurality of incubators are wirelessly connected (such as WLAN, Bluetooth) from the base station. In another embodiment, combinations of wire-bound and wire-free communication are defined for the invention.

The measuring units located on a shaker platform within an incubation environment, the communication structure between the individual measuring units, and a base station for data processing and/or data recording require an electrical device for wired or wireless data transfer. Each measuring unit has, for example, a radio transmitter or receiver which establishes a local radio network to a fixedly positioned central radio transmitter or receiver. With common data transfer technology, for example, Bluetooth or WLAN can be used. All measuring units or their electronic units have, in one embodiment, a device-internal permanent data memory for recording measured data. The central radio transmitter or receiver is connected via a data interface to a data processing and/or data recording device such as a computer. Computers include, for example, desktops, notebook computers, tablet computers, or smart phones.

The invention provides a device, a method, and a system for automated and parallel detection of at least one variable process size of cell suspensions in continuously and non-continuously shaken, square containers (microbioreactors) that define a matrix. Continuous monitoring of critical process parameters in the area of commercial biotechnology and R & D is necessary for the assessment of growth processes or the ability to divide cell cultures (prokaryotes and eukaryotes). This measurable property of cells is used to determine optimal cultivation conditions, beneficial nutrients and substrates, beneficial cell strains and genetic variants, growth inhibitors, and toxins from a plurality of variations.

The invention has the advantage that any changes in turbidity as well as changing cell and biomass concentrations as a result of cell proliferation processes in living cultures can be monitored and recorded over the entire cultivation time. The underlying measuring principle is based on the irradiation of electromagnetic waves into the cell suspensions present in the containers, each container having a radiation source immovable relative to the container, the radiation source being assigned to a corresponding light sensor. All measuring operations can be triggered and recorded in either continuous or non-continuous shaking modes.

Fields of application of the invention primarily comprise the simultaneous monitoring of variable process variables of highly parallelized biological and (bio) chemical processes with up to 240 containers of 500-11000 μl each within an incubation/shaking environment. The strong miniaturization of the measurement carriers for every twenty-four containers enables the use of at least one measurement carrier per incubation environment.

In an embodiment, the plurality of containers combined into a matrix, referred to as a microtiter plate, is produced from plastic using an injection molding or molding process. The plastic can be, for example, polycarbonate or polystyrene. The injection molding or molding method can also be a multi-component method.

The system works best in the dark. The preferred version may be provided with a cover (cap) or operated in a dark shaker. When measuring phototrophic organisms with artificial lighting, the lighting would have to be turned off during the measurement.

Measured process variables are generally turbidity and optical density, and in particular cell density, biomass and cell concentration, pH value, O₂ saturation of the fluid, and ambient temperature.

The integration of as many measurement carriers as possible (cell culture incubators) is achieved by a high degree of miniaturization of the measurement carriers and measuring units.

The main areas of application are screenings (strain selection, genetic selections, toxicity tests) and bioprocess development operations (media optimization, substrate selection, O₂ entry optimization) in which biological or chemical changes in the turbidity of suspensions are monitored and reaction parameters are compared with one another in the same incubation environment.

### BRIEF DESCRIPTION OF THE DRAWINGS

The nature and mode of operation of the present invention will now be more fully described in the following detailed description of the invention taken with the accompanying figures, in which:

FIG. 1A shows a schematic side view of a container with a square cross-section used in the system according to the invention for a sample with the assigned measuring unit comprising a radiation source and a sensor;

FIG. 1B shows a schematic side view of another embodiment of a container used in the system according to the invention for a sample with the assigned measuring unit of radiation source and sensor;

FIG. 1C shows a perspective view of the container when used in the system according to the invention, wherein a liquid mountain builds up in the container during a shaking movement;

FIG. 2 shows a plan view of a base module for a matrix of a plurality of containers, each of the containers having the same cross-sectional shape;

FIG. 3 shows a sectional view of the base module along the section line marked A-A in FIG. 2;

FIG. 4 shows a plan view of an embodiment of a matrix of a plurality of rigidly interconnected containers, which substantially correspond to the embodiments described in FIGS. 1-2;

FIG. 5 shows a plan view of an embodiment of a matrix of a plurality of rigidly interconnected containers, wherein the matrix is mounted stationarily on a measurement carrier;

FIG. 6 shows an enlarged view of the area marked B in FIG. 5;

FIGS. 7A-7B each show a cross section of an embodiment of the optical system for collimating the electromagnetic radiation emitted by the radiation source;

FIG. 8 shows a plan view of the rigidly connected containers of the matrix, wherein only those containers of the matrix are filled with the liquid sample, which form a sufficient accumulation (collection) of the liquid sample for measurement during the movement of the measurement carrier on the wall with the reflection element;

FIG. 9 shows a plan view of the rigidly connected containers of the matrix, wherein the containers of the matrix are filled in groups with the liquid sample, so that during the movement of the measurement carrier, on the wall with the reflection element, an accumulation of the liquid sample sufficient for the measurement is formed;

FIG. 10 shows a sectional view of the matrix of the containers, wherein the matrix is seated on a measurement carrier according to an embodiment;

FIG. 11 shows a plan view of an arrangement of the matrix of a plurality of containers in rigid connection to one another according to another embodiment of the measurement carrier;

FIG. 12 shows a sectional view along the section line B-B, which is marked in FIG. 11, of the measurement carrier for the matrix of the containers, wherein the measurement carrier is placed on a moving component;

FIG. 13 shows the arrangement of a plurality of microtiter plates with the rigidly interconnected containers in an incubator;

FIG. 14 shows a schematic arrangement of an incubator to a computer, which provides for the recording and evaluation of the measurement results of the substances in the containers of the microtiter plates, which are introduced in the incubator; and,

FIG. 15 shows a flow chart of an embodiment of the method according to the invention.

### DETAILED DESCRIPTION OF THE DRAWINGS

The drawings merely show embodiments of how the one or more containers according to the invention or the device according to the invention can be configured. The drawings expressly do not limit the invention to these embodiments. At the outset, it should be appreciated that like reference numbers on different figures identify identical, or functionally similar, structural elements of the invention. It is to be understood that the invention as claimed is not limited to the disclosed aspects.

Furthermore, it is understood that this invention is not limited to the particular methodology, materials, and modifications described and as such may, of course, vary. It is also understood that the terminology used herein is for the purpose of describing particular aspects only, and is not intended to limit the scope of the present invention as claimed.

Unless defined otherwise, all technical and scientific terms used herein have the same meaning as commonly understood to one of ordinary skill in the art to which this invention pertains. It should be understood that any methods, devices or materials similar or equivalent to those described herein can be used in the practice or testing of the invention.

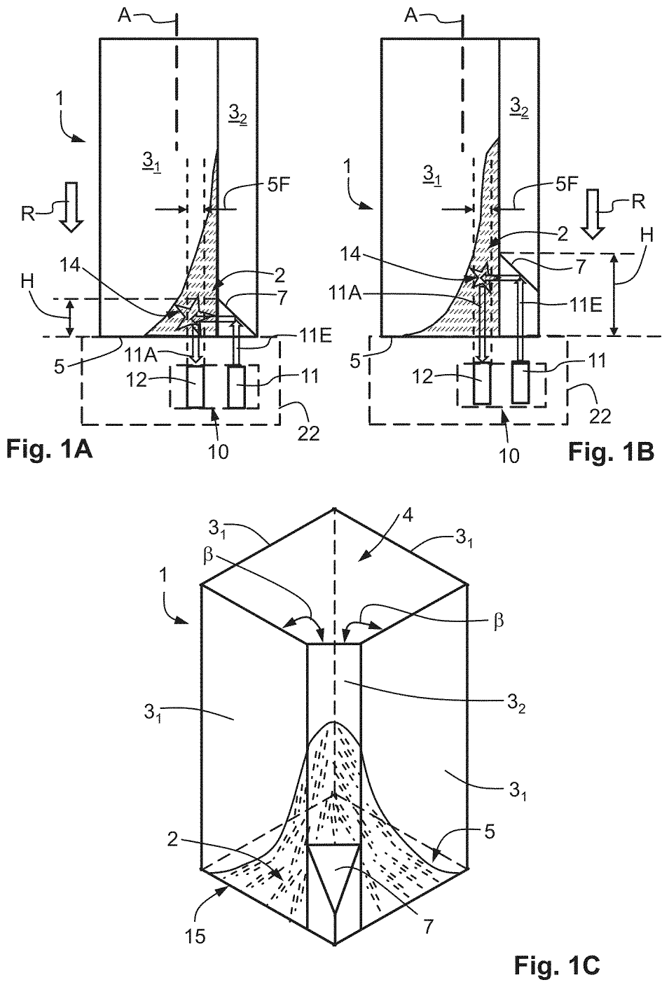

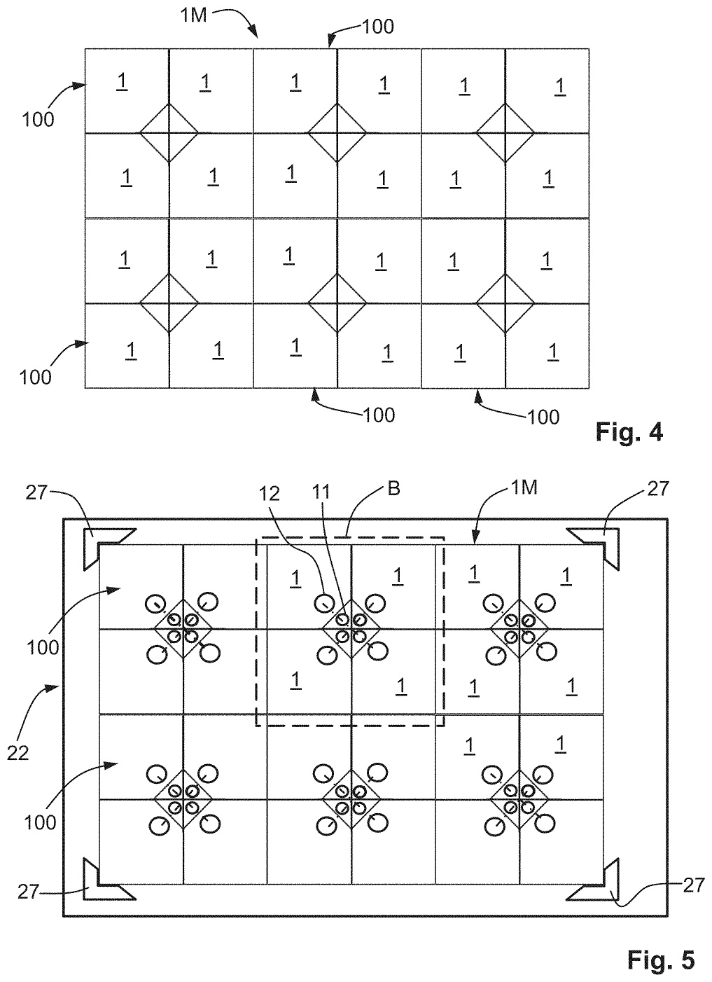

Referring now to the figures, FIGS. 1A, 1B, and 1C show different views and embodiments of a container 1 according to the invention, which can be used in the system according to the invention. The embodiments shown in FIGS. 1A, 1B, and 1C are not to be construed as limiting the invention. The container 1 can be used individually or in the form of a matrix 1M (see FIG. 4).

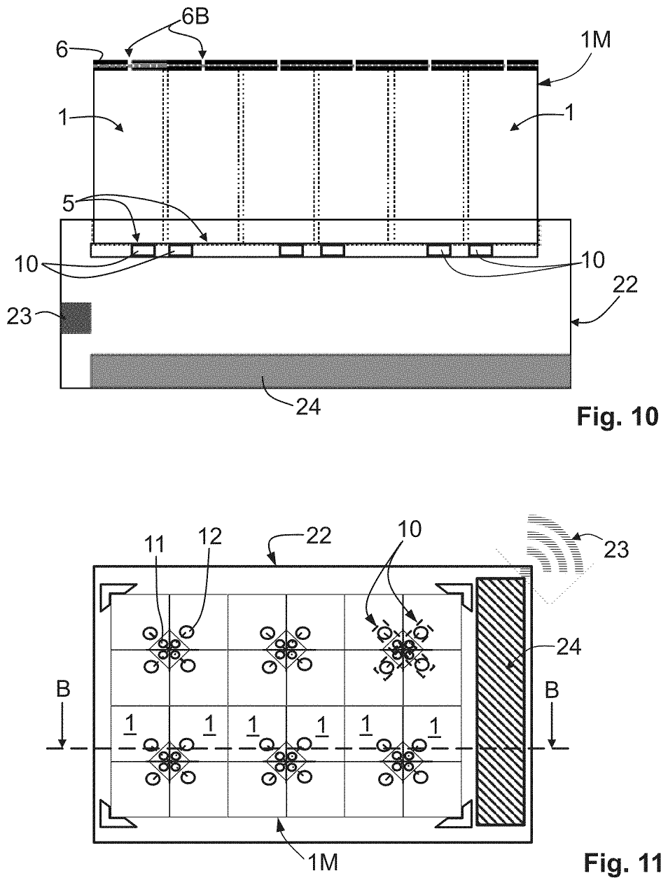

FIG. 1A shows a schematic side view of the embodiment of a container 1. The container 1 serves to receive a liquid sample 2. In the system according to the invention, each container 1 is assigned a measuring unit 10. The liquid sample 2 is a fluid medium (liquid), which is present in the form of for example, a solution, an emulsion, or a suspension. The liquid sample 2 may also be a fluid medium in which microorganisms develop. As can be seen from the illustration of FIG. 1C, the container 1 is constructed from a bottom 5 and a plurality of walls 3₁ connected to the bottom 5. Opposite the bottom 5, an opening 4 is provided, through which the container 1 can be filled with the liquid sample 2. If necessary, the opening 4 of the container 1 or the containers 1 can be closed with a cover 6 (see FIG. 10).

As can be seen from the illustration of FIG. 1C, the container 1 has a substantially square bottom surface 15. In addition, a wall 3₂ is provided which encloses an obtuse angle β with the adjacent walls 3₁ in each case. On the wall 3₂, a reflection element 7 is formed. Each container 1 is assigned to a measuring unit 10, which has a radiation source 11 and a sensor 12. The measuring unit 10 is provided in a measurement carrier 22. In an correctly aligned placement of the container 1 on the measurement carrier 10, the radiation source 11, the reflection element 7, and the sensor are assigned to the bottom 5. For the measurement on the fluid sample 2 and/or for the cultivation, the container 1 is moved (agitated) in a suitable manner. Sample 2 is a fluid medium (liquid) which is present, for example, in the form of a solution, an emulsion, or a suspension. The fluid sample 2 may also be a fluid medium in which microorganisms develop.

A beam 11E is directed from the radiation source 11 through the wall 3₂ onto the liquid sample 2 in the container 1 via the reflection element 7. Preferably, the beam 11E is then directed to the sample 2 when, due to the movement, the fluid sample 2 has accumulated on the wall 3₂. This has the advantage that a sufficiently large amount of the fluid sample 2 is available for the measurement. The sensor 12 of the measuring unit 10 detects the radiation 11A emerging from a scattering region 14 of the fluid sample 2 through the bottom 5. For this purpose, the bottom 5 itself or at least a portion 5F of the bottom 5 is transparent for a wavelength range of the radiation 11A emanating from the scattering region 14.

The reflection element 7 is an integral part of the wall 3₂. Preferably, the container 1 is produced by means of an injection molding process from a plastic. The embodiments of the container 1 shown in FIGS. 1A and 1B differ in that the reflection element 7 is attached to the wall 3₂ at a different height H in each case. The reflection element 7 is preferably arranged such that the beam 11E from the radiation source 11 passes through the wall 3₂ substantially perpendicularly. According to an embodiment, the wavelength of the beam 11E (light) emanating from the radiation source 11 is 600 nm to 900 nm.

The bottom 5 or the portion 5F of the bottom surface of each container 1 is configured such that it is transparent in an orthogonal direction R for electromagnetic radiation 11A (light) from the sample 2. At least one measurement on the sample 2 is for obtaining information by an optical method, wherein the determination of at least one variable (such as, for example, turbidity, biomass, or cell concentration) is made during an uninterrupted, defined, radial movement of the container or containers 1 about a fixed axis A, wherein the movement is orthogonal to the gravitational force. The radius of the movement may be between 0.5 mm and 50 mm. The frequency of the movement may be between 0 and 2000 revolutions per minute (rpm).

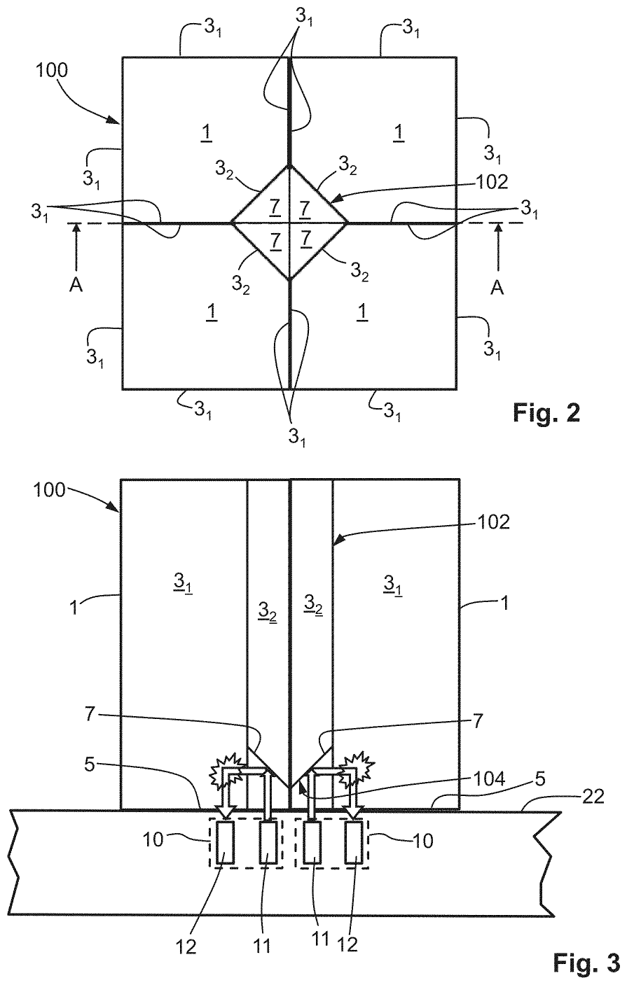

FIG. 2 shows a plan view of a base module 100 for a matrix 1M (see FIG. 4) of a plurality of containers 1. Each of the containers 1 has the same cross-sectional shape. Each of the containers 1 of the base module 100 is bounded laterally by the walls 3₁ and the wall 3₂, which is assigned to the reflection element 7. The entire matrix 1M (see FIG. 4) and thus also the base module 100 can be produced by an injection molding process. The injection molding process can be configured as one-, two- or multi-component injection molding. The base module 100 is constructed from four containers 1 connected to one another. A central channel 102 is assigned to each of the containers 1 of the base module 100. Through the central channel 102, in each case a wall 3₂ of each of the four containers 1 is defined, which wall 3₂ carries the reflection element 7. In the embodiment shown here, the channel 102 has a square cross-sectional shape.

FIG. 3 shows a sectional view of the base module 100 along the section line A-A marked in FIG. 2. The matrix 1M and thus also the base modules 100 can be manufactured with a suitable tool in an injection molding process. The channel 102 has an end 104 which has the shape of a pyramid. The pyramid defines the reflection element 7 for each of the four walls 3₂ of the base module 100. When the matrix 1M with the base modules 100 is placed on the measurement carrier 22, the sensor 12 of each measuring unit 10 is assigned to the reflection element 7. Likewise, the sensor 12 of each measuring unit 10 is assigned to the bottom 5 of each container 1.

FIG. 4 shows a plan view of an embodiment of a matrix 1M comprising a plurality of containers 1 which are rigidly connected to one another, and the containers 1 essentially correspond to the embodiments of the containers 1 described in FIG. 1 or FIG. 2. In the embodiment shown here, the matrix 1M consists of six base modules 100. The matrix 1M thus comprises twenty-four containers 1. It will be understood by a person skilled in the art that the number of containers 1 of the matrix 1M should not be construed as limiting the invention.

FIG. 5 shows a plan view of an embodiment of a matrix 1M comprising a plurality of containers 1 (microbioreactors, wells) which are rigidly connected to one another and which are mounted in a stationary manner on a measurement carrier 22. For this purpose, a plurality of positioning aids 27 (stops) are provided on the measurement carrier 22. By means of the positioning aids 27 it is ensured that when placing the matrix 1M on the measurement carrier 22, each container 1 of the matrix 1M the radiation source 11 and the sensor 12 of the measuring unit 10 are assigned at defined positions.

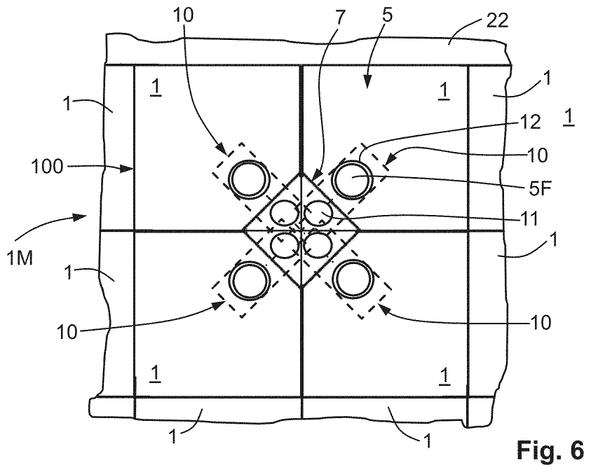

The assignment of the radiation source 11 and the sensor 12 of the measuring unit 10 to the containers 1 is illustrated in FIG. 6 on the basis of an enlarged illustration of the area marked B in FIG. 6. For this purpose, a base module 100 of the matrix 1M is shown enlarged. The radiation source 11 of the measuring unit 10 is assigned to the reflection element 7 of a container 1 in the matrix 1M placed on the measurement carrier 22. The sensor 12 of the measuring unit 10 is then assigned to the bottom 5 or a portion 5F of the bottom 5, which is transparent to the electromagnetic radiation 11A (light) emanating from the sample 2. The shape and that of the portion 5F of the bottom 5 should not be construed as limiting the invention.

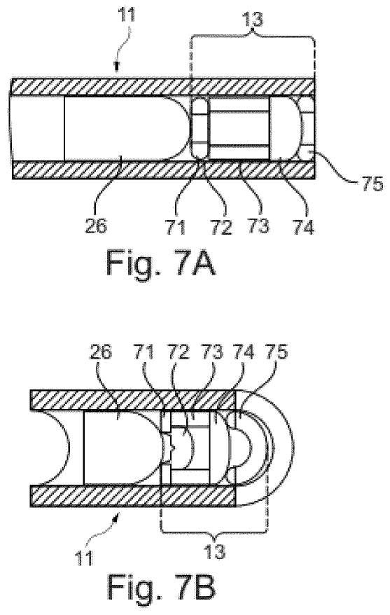

FIGS. 7A-7B each show a cross section through an embodiment of the optical system 13 for collimating the electromagnetic radiation emitted by the radiation source 11. In one embodiment, the radiation source 11 consists of the light-emitting diode 26 followed by an optical system 13. The optical system 13 is composed of a spacer 71, at least one pinhole aperture 72, a further spacer 73, an optical lens 74 and a spacer 75. The pinhole aperture 72 serves to reduce the specific radiation angle of the light-emitting diode 26. The light cone emerging from the pinhole aperture 72 is focused by means of the optical lens 74, whereby a high depth of focus of the projection is achieved.

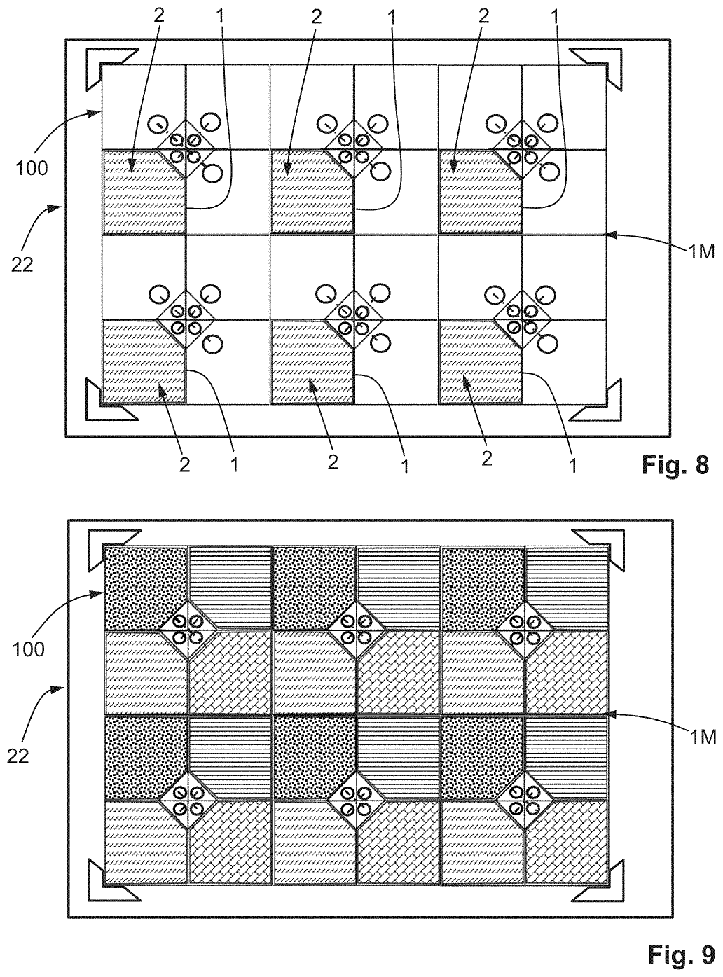

FIG. 8 shows a plan view of the rigidly connected containers 1 of the matrix 1M, wherein only those containers 1 of the matrix 1M are filled with the liquid sample 2, which containers 1 form, during the movement of the measurement carrier 22, at substantially the same time on the wall 3₂ with the reflection element 7, an accumulation of the liquid sample 2 sufficient for the measurement.

FIG. 9 likewise shows a plan view of the rigidly connected containers 1 of the matrix 1M. Here, all containers 1 of the matrix 1M are filled with a liquid sample 2. The different patterns of the containers 1 of each base module 100 of the matrix 1M indicate that during the movement of the measurement carrier 22, the accumulation of the liquid sample 2 at different times in each container 1 of each base module 100 on the wall 3₂ with the reflection element 7 occurs. The different pattern filling of the containers 1 represents the division of the containers 1 into groups. According to an embodiment, the measurement, if a sufficient accumulation of the liquid sample 2 is formed in the respective container 1, is carried out in a clocked manner. This means that the radiation sources 11 of the containers 1 of a specific group are switched on at the same time.

FIG. 10 shows a side view of the matrix 1M, which consists of the plurality of rigidly connected containers 1 arranged on an embodiment of the measurement carrier 22. The measurement carrier 22 serves to receive the matrix 1M of containers 1 (microbioreactors, wells). In this embodiment, all containers 1 are covered with a cover 6 during the measuring process. The cover 6 is provided with bores 6B. Each of the containers 1 is assigned to a bore 6B. The cover 6 is a sterile barrier in the form of a membrane or other porous semipermeable layer. The sterile barrier allows the gas exchange in both directions, whereby, for example, microorganisms are supplied with oxygen or metabolic products such as CO₂ are discharged. The measurement carrier 22 carries the plurality of measuring units 10 at defined positions which are assigned to the bottom 5 of each container 1 fixed in each case in the matrix 1M placed on the measurement carrier 22. The measurement carrier 22 further comprises an electronic module 24, which is in communication with the measuring units 10. The power supply of the measuring units 10, the electronic module 24 and the data connection 23 is carried out in a manner known in the art.

FIG. 11 shows a plan view of a matrix 1M comprising a plurality of containers 1, wherein the matrix 1M is positioned in an exact position (accurately aligned) on the measurement carrier 22. In the embodiment shown here, the measurement carrier 22 has further formed an electronic module 24, which provides for the power supply of the individual measuring units 10 and a communication to measuring units 10 (within a sensor network) on the measurement carrier 22 via connection technologies known in the art. A data connection 23 to a base station 30 or computer (see FIG. 14) is provided. The data connection 23 is a wireless communication in the embodiment described herein. Through the communication with the base station 30 or computer (for data processing and/or data recording), the active containers 1 filled with a sample 2 and the at least one measurement carrier 22 of the measuring system can be combined to form a communicating network of the measuring units 10.

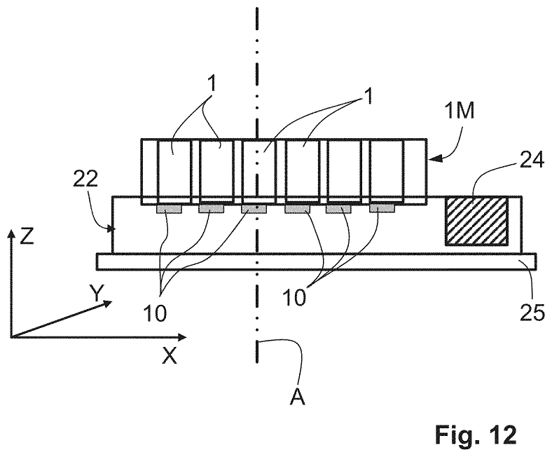

FIG. 12 shows a sectional view along the section line B-B of the measurement carrier 22 marked in FIG. 11 and the matrix 1M placed thereon. The measurement carrier 22 is placed on a moving component 25. In this way, the matrix 1M of the containers 1, which is stationarily connected to the measurement carrier 22, can be affected with a defined movement. For the measurement on the sample 2 in the individual containers 1 and the determination of at least one variable of the sample 2, an uninterrupted, defined, radial, and orthogonal to gravitational force movement of the matrix 1M of the containers 1 on the measurement carrier 22 can be carried out about a fixed axis A. The movement is composed at least of movement components in an X-coordinate direction X and/or a Y-coordinate direction Y. The individual containers 1 of the matrix 1M are assigned on the measurement carrier 22 in a stationary manner to the measuring units 10 of the measurement carrier 22 for the determination of the at least one variable of the sample 2. The measured values of the measuring units 10 are transmitted to the base station 30 (see FIG. 14) with the electronic module 24 or the data connection 23.

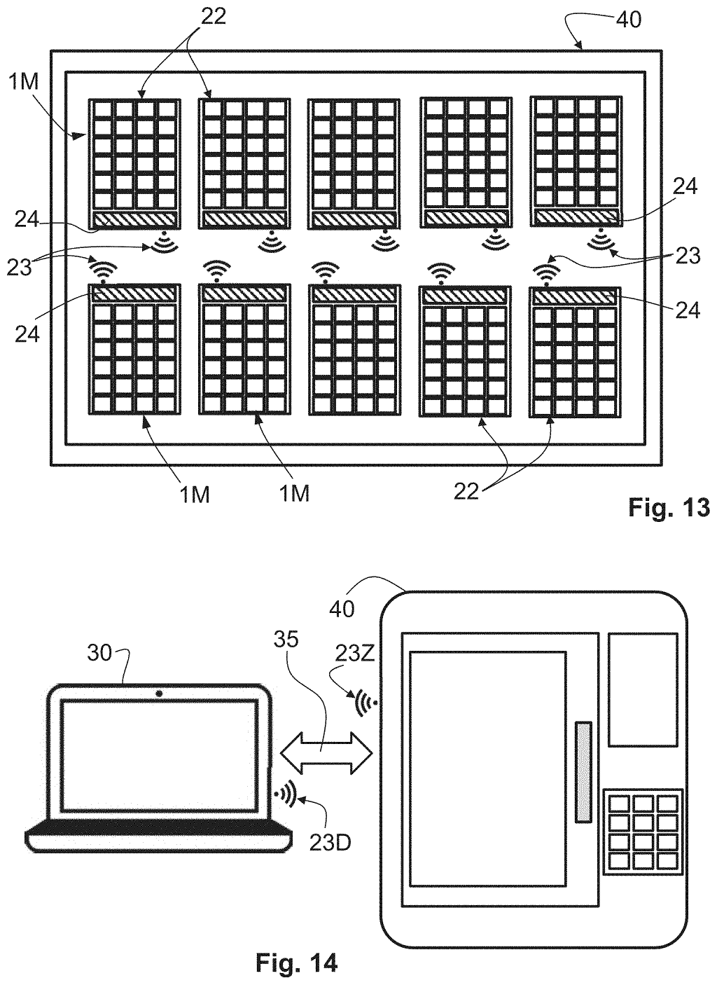

FIG. 13 shows the arrangement of a plurality of measurement carriers 22, each having a matrix 1M arranged thereon of a plurality of containers 1 in an incubator 40. In the measuring system shown here, ten measurement carriers 22 (measuring units) are introduced in the incubator 40 with a matrix 1M of in each case twenty-four containers 1 arranged thereon for the samples 2. This achieves a continuous, optical measurement and recording of scattered light which is produced on the biological material in the individual containers 1 as a result of the irradiation with light. By means of a single measurement carrier 22, an uninterrupted, non-invasive, and simultaneous measurement can be carried out on the twenty-four containers 1 per measurement carrier 22 during the use in incubators 40 for bacterial and mammalian cell cultures in the radial shaking mode. By miniaturization of the measurement carrier 22, up to ten measurement carriers 22 can be arranged and operated simultaneously within a shaker or incubation environment. The communication of the individual measuring units 10 assigned to the containers 1 of the respective carrier 22 (measuring unit) is controlled by the electronic module 24. The communication of the measuring units 10 is carried out via a respective data connection 23, for example, a radio connection (Bluetooth, WLAN).

FIG. 14 shows a schematic arrangement of an embodiment of an incubator 40 in conjunction with a base station or computer 30, which carries out the recording and evaluation of the measurement results of the substances in the containers 1 (microbioreactors). To support the processes of interest in a respective test, the measurement carriers 22 with the plurality of containers 1 can be moved in the incubator 40. This is preferably done mechanically. Corresponding devices known in the art are, for example, shakers or rockers. Such devices are commercially available in various embodiments, which can move a container 1, but also a plurality of containers 1, on a measurement carrier 22 simultaneously in a defined manner. All these devices have adequate space in the incubator 40. The base station 30 is connected to the incubator 40 via a bidirectional communication connection 35 to receive data from the measurement carriers 22 in the incubator 40, and, for example, to send control data from the base station 30 to the incubator 40 itself or to the electronic modules 24 of the carrier 22.

According to a preferred embodiment, each measuring unit 10 has a data connection 23, which is a radio transmitter or receiver, with which a local radio network is established as a permanently stationed, central data connection 23Z, being also a radio transmitter or receiver. In the data transfer technology used, for example, Bluetooth or WLAN can be used. All measuring units 10 also have a device-internal, permanent data memory for recording measurement data. The central radio transmitter or receiver is connected via a data interface 23D to a base station 30 (data processing and/or data recording device), such as, for example, a computer such as, for example, a desktop computer, a notebook computer, a tablet computer or a smart phone.

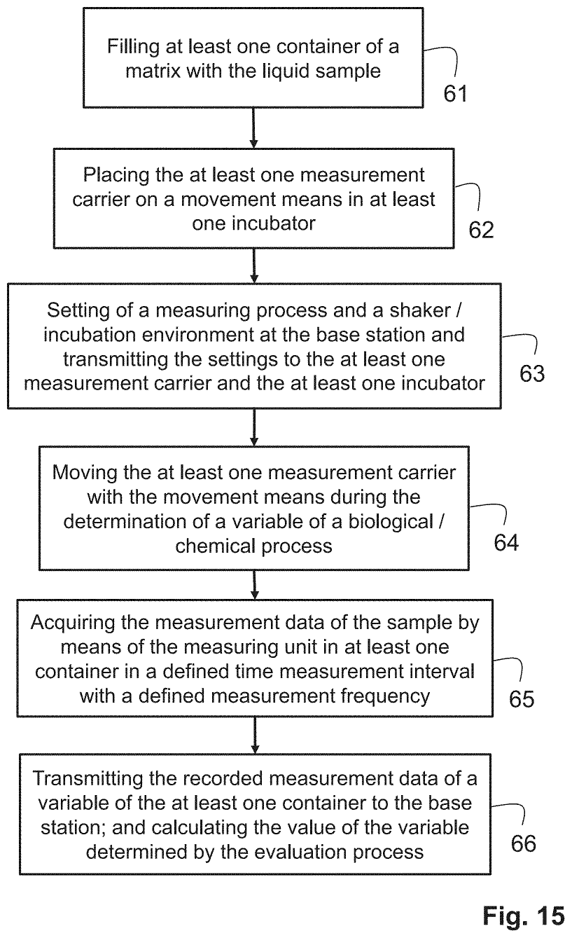

A flow chart of the method according to the invention of the parallelized detection of cell and biomass concentrations of cell cultures (liquid sample 2) is shown in FIG. 15. In a step 61 at the beginning of the method according to the invention, at least one container 1 of a carrier 22 is filled with a liquid sample 2 (constitution and properties of the sample are described sufficiently above). The containers 1 are arranged regularly in columns 9 and lines 8, in the form of a matrix, stationary on the carrier. The opening 4 of the containers 1 can be closed with a cover 6 (see FIG. 10) so that the liquid sample 2 does not pass beyond the container 1 during the measuring process or the cultivation.

In a next step 62, the at least one measurement carrier 22 is placed on a moving component 25. The measurement carrier 22 and the moving component 25 can be introduced into at least one incubator 40, which is communicatively connected to the base station 30. It should be noted that in another embodiment of the method, the incubator can also be omitted.

In step 63, a measuring process and a shaker or incubation environment are set at the base station 30. The settings are transmitted to the at least one measurement carrier 22 and possibly to the at least one incubator 40 (if necessary also to the moving component 25). By setting the measuring process, the grouped containers 1 of a matrix can thus be measured with a time-delay. The setting of the measuring process can comprise, for example and without being limited thereto, the incubation conditions, the radial movement pattern (such as, for example, repetition frequency and direction of rotation, since the type of movement “radial” is previously predetermined) of the moving component 25, the control of the radiation source 11, the definition of the measurement frequency for a measurement time interval (for the generation of a measured value, the user only sets, for example, that every 10 seconds a measured value is to be detected), or the setting of the wavelength emitted by the radiation source 11.

In step 64, the movement of the at least one measuring carrier 22 is carried out with the moving component 25 assigned to the measurement carrier 22. During the movement of the measurement carrier 22 according to a defined movement pattern, the determination of a variable of the biological or chemical process is made. The movement of the carrier 22 may be performed, for example, continuously and with a defined, radial, and orthogonal to gravitational force S extending movement about a fixed axis A.

In a step 65 parallel in time to step 64, the measuring unit 10 acquires the measurement data of the liquid and moving sample 2 present in the at least one container 1. The acquiring (recordation) of the measurement data is carried out at a defined time measurement interval with a defined measurement frequency of at least 50 Hz. In each container 1, in which a sample is located, the measured data are recorded with the sensor 12 of the measuring unit 10. A respective measuring unit 10 is permanently assigned to the respective containers 1, the measuring units 10 being arranged stationarily on the measurement carrier 22 for the containers 1 (for example, a microtiter plate). The measuring unit 10 comprises the controllable radiation source 11 and the at least one sensor 12.

In step 66, finally, the transmission of the recorded measurement data of a variable in the at least one container 1 is carried out. The measurement data are transmitted from the incubator 40 to the base station 30 (or a suitable evaluation unit). The base station 30 is used to calculate the value of the variable determined by the evaluation process. The variable is, for example, the turbidity and the optical density of liquid samples, the cell density, biomass and cell concentration, pH value, O₂ saturation of the liquid, or the ambient temperature. For the determination of the pH value or the O₂ saturation of the liquid, sensor pads (not shown here) are glued into the container. The pH value or the O₂ saturation are detected as an optical response by the sensor 12 assigned to the respective container, said sensor 12 having been previously illuminated with a light source. The relative saturation of dissolved oxygen in the respective sample 2 is regulated by a change in the energy input during the movement of the containers 1 or of the carrier 22 by the movement pattern of the moving component 25. It is particularly advantageous if the recorded measurement data are transmitted via a data connection 23 (for example, via radio) from the incubator 40 to the base station 30, since the source of error of a cable break is eliminated.

### LIST OF REFERENCE NUMERALS

1 Container
1M Matrix
2 Sample
3₁ Wall
3₂ Wall
5 Opening
5 Bottom, Base
5F Portion of the bottom
6 Cover
6B Bore
7 Reflection element
10 Measuring unit
11 Radiation source
11A Radiation from the sample
11E Beam from the radiation source
12 Sensor
13 Optical system
14 Scattering region
15 Bottom surface
22 Measurement carrier
23 Data connection
23D Data interface
23Z Central data connection
24 Electronic module
25 Moving component
26 Light-emitting diode
27 Positioning aid (stop)
30 Base station
35 Bidirectional communication connection
40 Incubator
61 Step
62 Step
63 Step
64 Step
65 Step
66 Step
71 Spacer
72 Pinhole aperture
73 Spacer
74 Optical lens
75 Spacer
100 Base module
102 Channel
104 End
A Axis
A-A Intersection line
B Area
B-B Intersection line
H Height
R Orthogonal direction
S Gravitational force
X X coordinate direction
Y Y coordinate direction
Z Z-coordinate direction
β Obtuse angle

What is claimed is:

1. A system for detecting at least one variable of a liquid sample, the system comprising:
a container formed by a bottom, a plurality of walls, and an opening opposite the bottom, wherein the container receives the liquid sample to perform a biological or chemical process in the container;
a single wall of the container, forming an obtuse angle with the adjacent walls respectively;
a reflection element is formed on the wall; and,
a measuring unit having a radiation source and a sensor is assigned to the bottom of the container in such a way that a beam emerging from the radiation source is directed to the reflection element and from there through the wall to the liquid sample in the container, wherein the bottom is transparent for a wavelength range of a radiation emerging from the liquid sample, and the sensor of the measuring unit receives radiation from the sample.

2. The system according to claim 1, wherein the container is made of a plastic by means of an injection molding process, and the reflection element is an integral part of the container.

3. The system according to claim 1, wherein at least a portion of the wall assigned to the reflective element is transparent for a wavelength range of the beam from the radiation source, and wherein at least a portion of the bottom assigned to the sensor is transparent for a wavelength range of the radiation from the sample.

4. A device for detecting at least one variable of at least one liquid sample during a biological or chemical process, the device comprising:
a measurement carrier
a moving component for moving the measurement carrier in a combined movement composed of an X-coordinate direction and a Y-coordinate direction;
a matrix of a plurality of containers rigidly connected to one another, each of the containers is defined by a bottom, a plurality of walls and an opening opposite the bottom;
a base module of the matrix which is constructed of four containers connected to one another, the matrix being composed of a plurality of base modules which are also rigidly connected to one another;
a central channel of the base module which defines a respective wall of each of the four containers;
an end of the channel of the base module which defines four reflection elements, one respective reflection element being assigned to the wall of each container of the base module; and
a plurality of measuring units arranged in the measurement carrier, each measuring unit having at least one controllable radiation source of electromagnetic radiation and at least one sensor for detecting electromagnetic radiation, wherein the plurality of measuring units is arranged in a distribution throughout the measurement carrier in a way such that, when the matrix is seated on the measurement carrier, one respective radiation source is assigned to each reflection element of each container and at least one respective sensor is assigned to the bottom of each of the containers.

5. The device according to claim 4, wherein a plurality of stops is provided which position the matrix in an accurately aligned manner on the measurement carrier, and each container of the matrix is assigned a respective measuring unit such that each reflection element of each container is assigned a radiation source and each bottom is assigned a sensor.

6. The device according to claim 4, wherein the bottom of each container of the matrix is configured such that it is transparent to the electromagnetic radiation from the controllable radiation source into the liquid sample and to the electromagnetic radiation emanating from the liquid sample to the at least one sensor.

7. The device according to claim 4, wherein the radiation source is at least one light-emitting diode, wherein an optical system for guiding and forming the electromagnetic radiation is arranged downstream of said at least one light-emitting diode.

8. The device according to claim 7, wherein the optical system is composed of at least one pinhole aperture and an optical lens, the optical lens collimating the electromagnetic radiation in the liquid sample into a beam.

9. The device according to claim 4, wherein the moving component is configured to move the measurement carrier in the X-coordinate direction and in the Y-coordinate direction with a defined, radial, and orthogonal to the gravitational force extending movement about a fixed axis.

10. The device according to claim 4, wherein the measurement carrier is provided with an electronic module which is communicatively connected to each sensor of each measuring unit, and the electronic module is connected to a base station via a data connection.

11. The device according to claim 4, wherein the moving component is dimensioned such that up to ten measurement carriers can be placed on the moving component, whereby an uninterrupted, non-invasive, and simultaneous measurement on a plurality of containers of a matrix on a plurality of measurement carriers can be carried out.

12. The device of claim 11, wherein at least one incubator is provided, in which the moving component and the at least one measurement carrier are accommodated.

13. The device of claim 12, wherein a plurality of measurement carriers are positioned in a plurality of incubators such that the measurement carriers are subject to different incubation environments and movement patterns of the moving component.

14. A method for detecting at least one variable of a liquid sample during a biological or chemical process, the method comprising the steps of:
filling at least one container of a matrix of a plurality of containers with the liquid sample, the matrix being made up of a plurality of base modules, each base module being composed of four containers connected to one another, wherein a central channel defines a respective wall of each of the containers, and an end of the channel of the base module defines four reflective elements, wherein a respective reflection element is assigned to the respective wall of each container of the base module;
placing the matrix on a measurement carrier such that each of the plurality of measuring units arranged in the measurement carrier is assigned to one of the containers of the matrix, so that at least one controllable radiation source of the measuring unit is assigned to the reflection element of each container, and at least one sensor of the measuring unit is assigned to a bottom of each container;
moving the measurement carrier in the X coordinate direction and in the Y coordinate direction, wherein the movement of the measurement carrier is performed radially and orthogonal to the gravitational force about a fixed axis, and wherein in each base module of the matrix, depending on the movement, the liquid sample alternately accumulates on the wall of each container of the base module;
triggering the at least one controllable radiation source of each measuring unit in such a way that via reflection element and the wall of each container, electromagnetic radiation is irradiated into the sample just accumulated on the wall of the respective container; and
collecting, with the respective sensor of the respective measuring unit, the electromagnetic radiation emerging through the respective bottom of each container of the matrix, wherein a determination of the at least one variable during the biological or chemical process is performed in the at least one container of the matrix.

15. The method according to claim 14, wherein a beam of the measuring unit emerging from the radiation source is irradiated through the wall into the respective container of the base module or matrix, and wherein the optical sensor of the measuring unit receives the electromagnetic radiation emerging through the bottom from the liquid sample accumulated on the wall of each container.

16. The method according to claim 14, wherein the containers of the matrix are measured with their assigned measuring units of the measurement carrier in such a way that the containers in the base module are grouped, and measured values are obtained from the containers of each base module with a time delay.

17. The method according to claim 14, wherein the at least one variable in each container of the matrix is recorded in a defined measurement interval with a measurement frequency of at least 50 measurement events per second, and wherein the recorded measurement data of the at least one variable of each container of the matrix are processed independently of one another according to a mathematical method in a defined time measurement interval and converted into a value of the variables determined temporally after the beginning of the process.

18. The method according to claim 17, wherein the measured values obtained with a time delay are transmitted to a base station by means of a data connection.
